(19) United States
(12) Patent Application Publication
(10) Pub. No.: US 2009/0318303 A1
(43) Pub. Date: Dec. 24, 2009

(54) MICROFLUIDIC SELECTION OF LIBRARY ELEMENTS

(75) Inventors: Emmanuel Delamarche, Thalwil (CH); Robert Lovchik, Schoenenberg (CH); Daniel J. Solis, San Diego, CA (US)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/143,314

(22) Filed: Jun. 20, 2008

(51) Int. Cl. C40B 30/04; C40B 60/12; C40B 50/18

(52) U.S. Cl. 506/9; 506/39; 506/32

(57) ABSTRACT

Disclosed herein is a system comprising a chip; a flow channel disposed in the chip; the flow channel being in communication with an entry port and an exit port; the flow channel being operative to permit the flow of a library from the entry port to the exit port; a substrate; the substrate being disposed upon the chip; the substrate being operative to act as an upper wall for the flow channel; and a receptor; the receptor being disposed on the substrate; the receptor being operative to interact with a component from the library.

### BACKGROUND

This disclosure relates to the microfluidic selection of library elements.

It is desirable in virtually every area of the biomedical sciences to have systems that are based on chemical or biochemical assays for determining the presence and quantity of particular analytes. This desire ranges from the basic science research lab, where biochemical pathways are being mapped out and their functions correlated to disease processes, to clinical diagnostics, where patients are routinely monitored for levels of clinically relevant analytes. Other areas include pharmaceutical research and drug discovery applications, DNA testing, veterinary, food, and environmental applications. In all of these cases, the presence and quantity of a specific analyte or group of analytes, has to be determined.

For analysis in the fields of pharmacology, genetics, chemistry, biochemistry, biotechnology, molecular biology and others, it is often useful to detect the presence of one or more molecular structures and characterize interactions between molecular structures. The molecular structures of interest generally include antibodies, antigens, metabolites, proteins, drugs, small molecules, enzymes, nucleic acids, and other ligands and analytes. The molecular structures can also be inside or outside cells and microorganisms. In medicine, for example, it is very useful to determine the existence of cellular constituents such as receptors or cytokines, or antibodies and antigens which serve as markers for various disease processes, which exist naturally in physiological fluids or which have been introduced into the system. In genetic analyses, fragment DNA and RNA sequence analysis are very useful in diagnostics, genetic testing and research, agriculture, and pharmaceutical development. Because of the rapidly advancing state of molecular cell biology and understanding of normal and diseased systems, there always exists an increasing need for newer, more rapid, and more accurate methods of detection.

A useful technique for the identification of such molecular structures as well as interactions between molecular structures is high throughput screening of large collections of chemicals or biochemicals, often referred to as “libraries”. Most high-throughput screens measure the action of compounds on a single molecular phenomenon, e.g., a particular enzymatic activity that is thought to play a role in some physiological system such as a disease state. Prior to the screening process, the elements of such libraries have not been demonstrated to have action on the molecular phenomenon measured by the screen or the disease state in which the molecular phenomena plays a role. Such a screen is designed to identify compounds that affect that particular molecular phenomenon, so that the physiological system in which the phenomenon plays a role may be impinged upon with the identified compounds.

Screening of libraries is often conducted by using microtiter plates and bead based screening. In screening a library using a microtiter plate, a microtiter plate well is coated with a target of interest (e.g., a receptor). Bacteriophage libraries, more commonly called phage libraries, are often used for screening purposes. In these libraries, chemical variability is introduced in the genome of the phages and because a large number of phages can be contained in a small volume of library, large chemical diversity in the phages can be achieved. In the phage libraries, the variable part of the genome of a phage can be expressed and displayed as a coat protein. Therefore, screening a phage library can be accomplished by looking for interactions between a receptor of interest and a particular protein displayed on the surface of the phage. A phage library is then placed in contact with a well of an analytical device that contains a receptor of interest. Some of the phages bind to the receptor. The well is then washed to remove those phages that are not bound to the receptor. After removal of the unbound phages, those phages that are bound to the receptor are eluted. The DNA of some of the bound phages is then sequenced to assess the quality of the screening. The eluted phages are then copied to increase their numbers (amplification). The foregoing steps are then repeated until the genetic sequences of the bound phages show “consensus”. The emergence of a consensus shows that screening has resulted in extracting from the library one or a few phages that are able to bind the receptor with equal probability.

In bead based screening, a bead of latex, silica, or other suitable material having an average particle size of about 1 to about 10 micrometers is coated with a receptor of interest. The phage library is allowed to interact with the beads freely in solution. Unbound phages and beads are separated using either centrifugation or particle sorting machines based on multiple technologies (magnetic bead, dielectrophoresis, fluorescence). Phages bound to the bead are eluted. As noted above, the eluted phages are subjected to amplification followed by the same series of steps described above to show consensus.

Because of the number of steps, both of the aforementioned methods involving microtiter plates and bead based screening are expensive, time consuming and labor intensive. For example, a phage library can cost around $1,000 to purchase and 2 to 4 rounds of screening generally take about 3 weeks. In addition, both of the above methods use multiple cycles, which opens the method to contamination as well as degradation in the quality of results.

It is therefore desirable to have a method that can be used for screening phage libraries efficiently and inexpensively.

### SUMMARY

Disclosed herein is a system comprising a chip; a flow channel disposed in the chip; the flow channel being in communication with an entry port and an exit port; the flow channel being operative to permit the flow of a library from the entry port to the exit port; a substrate; the substrate being disposed upon the chip; the substrate being operative to act as an upper wall for the flow channel; and a receptor; the receptor being disposed on the substrate; the receptor being operative to interact with an element from the library.

Disclosed herein is a method comprising disposing a library on a loading pad of a microfluidic device; the microfluidic device comprising a chip; a flow channel disposed in the chip; the flow channel being in communication with an entry port and an exit port; the flow channel being operative to permit the flow of a library from the entry port to the exit port; a substrate; the substrate being disposed upon the chip; the substrate being operative to act as an upper wall for the flow channel; and a receptor; the receptor being disposed on the substrate; the receptor being operative to interact with an element from the library; adding a first solution to the loading pad to transport elements of the library through the entry port into the flow channel; binding a fraction of the elements of the library to the receptor to form a element-receptor complex; and eluting a element-receptor complex.

Disclosed herein a method of manufacturing a microfluid device comprising disposing a flow channel in a chip; disposing an exit port and a loading pad in the chip; disposing a metal layer on a base of the flow channel; disposing a substrate on the chip; the substrate being operative to act as an upper wall for the flow channel; and disposing a receptor on a surface of the substrate that is opposedly disposed to the metal layer; the receptor being operative to interact with an element of a library.

### BRIEF DESCRIPTION OF THE SEVERAL VIEWS OF THE DRAWINGS

FIG. 1A is an exemplary depiction of the side view of the microfluidic device;

FIG. 1B is an exemplary depiction of a cross-sectional view taken at AA′ of the microfluidic device depicted in the FIG. 1A;

FIG. 2 is another exemplary depiction of the microfluidic device;

FIG. 3 is a bar graph showing the efficiency of reduction of the library in a single round of screening;

FIG. 4 is a depiction of on embodiment of the microfluidic device where the loading pad is replaced with a via; and

FIG. 5 is a depiction of the sequences obtained after elution in the Example 2.

### DETAILED DESCRIPTION

Disclosed herein is a system and a method for selecting elements from a library by using a microfluidic device. The elements can be bacteriophages, viruses, self-assembled structures such as vesicles, or the like. The microfluidic device comprises a flow channel that is in communication with an entry port and an exit port through which a library may be introduced and removed. The flow channel is further covered with a substrate that is coated with a receptor (also called a target) that is selected for its ability to interact with a desired element from the library. Elements from the library react with the target during the transportation of the library through the flow channel. Following the reaction between the target and the element, non-bound elements can be removed by rinsing the flow channel, while the specific element that reacts with the target can then be separated and analyzed.

The system is advantageous in that it can be used to rapidly analyze the library. Whereas 2 to 3 rounds of screening are generally used when using conventional microtiter plates, the present system and method permit a strong reduction of the library that can be achieved in only one round. The system permits flow conditions in the microfluidic channel to be controlled so that reaction parameters such as diffusion and kinetics of binding are shifted in favor of facilitating a desired reaction between specific library elements and the targets. Since the microfluidic channels have channel dimensions that are on the order of micrometers, the fluid flow in the channel is always laminar. This permits efficient rinsing and minimizes the presence and influence of dead volumes. As a result, the flow of solutions is precise in volume and rate of flow. In addition, the rinsing of the microfluidic device can be very efficient. The dynamics of reactions are dramatically affected by scale; controlling the dimensions and flow conditions of the flow channel can shift reaction parameters such as diffusion and kinetics of binding in favor of selection. Furthermore, microfluidic flow channels are closed systems and can be used to eliminate outside contamination.

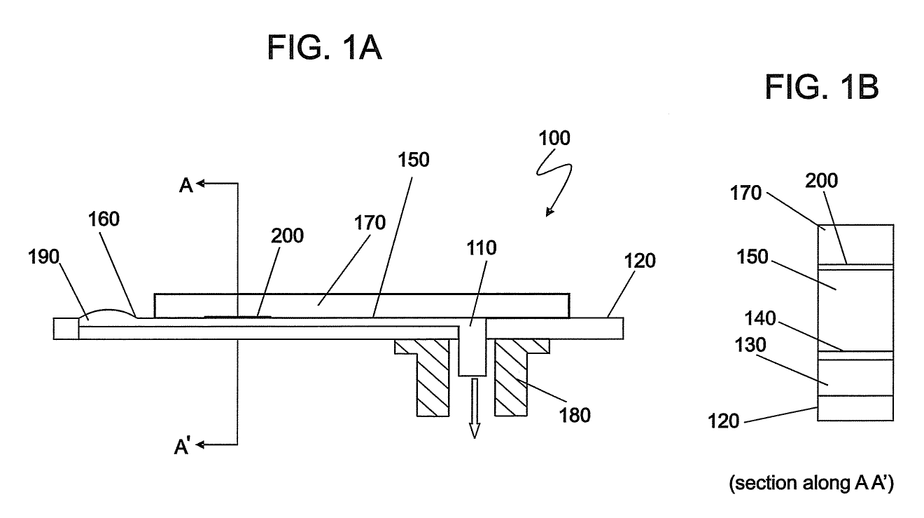

With reference now to the FIGS. 1A and 1B, an exemplary micro fluidic device 100 comprises a chip 120 having an entry port 160, an exit port 110 and a flow channel 150 disposed therein. The entry port 160 and the flow channel 150 are engraved in the chip 120. The entry port 160 is in communication with a loading pad 190, which is also engraved in the chip 120. The exit port 110 is engraved entirely through the chip and creates an opening on the face of the chip 120 that is opposed to the face upon which the flow channel 150 is disposed. The exit port 110 has a lip 180 disposed thereon. The lip 180 can be in fluidic communication with an optional pump (not shown). A metal layer 130 is deposited upon the entire chip 120 or specifically on the engraved structures that come into contact with the library. These structures are the loading pad 190, the entry port 160, the flow channel 150, and the exit port 110. A passivation layer 140 can be disposed upon the metal layer 130 across the entire surface of the microfluidic device or only in the flow channel 150 if desired.

The metal layer 130 generally comprises gold because it is easy to deposit gold on surfaces using sputtering techniques, thermal evaporation, electroless deposition or electroplating. Since, only a thin layer is used, the cost of gold is not an issue. The presence of the gold on the chip 120 helps modifying the wetting and protein-repellency properties of the chip. By always having gold on the chip, a general surface treatment can be developed and applied independently of the material used to fabricate the chip to place a passivation layer 140 on the metal layer. Alternatively, a metal other than gold can be used or the metal layer 130 can even be omitted if the surface properties of the chip permit the direct deposition of a passivation layer 140. In the rare eventuality that a library of low complexity is used and that this library has elements having straightforward interactions with receptors, the metal layer 130 and the passivation layer 140 can be omitted. As described above, the metal layer 130 coats the structures of the chip 120 inside which the library will pass and in particular it coats the flow channel 150.

The flow channel 150 has a passivation layer 140 that is disposed upon the metal layer 130. The passivation layer 140 may be hydrophobic or hydrophilic depending whether active pumping or passive pumping is used. Passive pumping refers to using capillary forces for spontaneously having the library flow through the chip 120. Passive pumping therefore requires the engraved structures of the chip to be hydrophilic. Active pumping can be done even if the engraved structures of the chip 120 are hydrophobic. Irrespective of its hydrophilicity/hydrophobicity, the passivation layer 140 should minimize or prevent the non-specific or undesirable deposition of library elements on the surface of the flow channel 150. Any element of the library that adheres to the chip 120 will be extracted from the library and might be retrieved and falsely identified as an element binding to the receptor. Hydrophilic passivation layers can comprise a thin polymeric film grafted to metal layer 130. In one embodiment, the hydrophilic polymeric film comprises a polymer that contains polyethylene glycol. A hydrophilic passivation layer can alternatively comprise a layer of deposited proteins such as albumin. A hydrophobic passivation layer can be formed by depositing a thin hydrophobic polymer on the chip 120. A fluorinated material can be used for example, for this purpose.

The substrate 170 is disposed upon the chip 120 and seals the flow channel 150, the entry port 160, and the exit port 110. The substrate should be in contact with the chip 120 so as to prevent the leakage of fluids. The substrate 170 may be manufactured from a suitable elastomer. If polydimethylsiloxane (PDMS) is used as material for the substrate 170, a spontaneous adhesive contact will occur between the chip 120 and the substrate 170, which will result in an efficient sealing of the flow channel in the chip. A list of elastomers is provided below with reference to the substrate. Alternatively, the substrate can be made from a material suitable for making the chip 120 and can be assembled by clipping it, bonding it, or gluing it to the chip 120. In one embodiment, the lip 180 and substrate 170 may have to be treated to prevent interactions of the elements of the library with the lip and the areas of the substrate that are not covered with a receptor 200. The receptor 200 is disposed on the substrate 170. The receptor 200 is selected for its ability to interact with a desired element from a library.

The chip 120 can be manufactured from a variety of different materials. Exemplary materials are semiconducting materials, metals, organic polymers or ceramics. Examples of suitable semiconductors are silicon, silicon dioxide, and silicon nitride, or the like, or a combination comprising at least one of the foregoing materials. Silicon wafers can for example be used. An exemplary metal chip is aluminum or stainless steel.

The organic polymer may be selected from a wide variety of thermoplastic resins, thermosetting resins, blends of thermoplastic resins, blends of thermosetting resins, or blends of thermoplastic resins with thermosetting resins. The organic polymer can comprise a blend of polymers, copolymers, terpolymers, or combinations comprising at least one of the organic polymers. The organic polymers can include semi-crystalline polymers or amorphous polymers. Examples of the organic polymers that can be used are polyolefins such as polyethylene, polypropylene; polyamides such as Nylon 4,6, Nylon 6, Nylon 6,6, Nylon 6, 10, Nylon 6, 12; polyesters such as polyethelene terephthalate (PET), polybutylene terephthalate (PBT); polyarylates, polyimides, polyacetals, polyacrylics, polycarbonates (PC), polystyrenes, polyamideimides, polyacrylates, polymethacrylates such as polymethylacrylate or polymethylmethacrylate (PMMA); polyethersulfones, polyvinyl chlorides, polysiloxanes, or the like, or a combination comprising at least one of the foregoing organic polymers. The organic polymer may also be based on silicone elastomers. Polydimethylsiloxane (PDMS) can be used, for example.

Examples of suitable ceramics are metal oxides. Examples of suitable metal oxides include silica (SiO₂), alumina (Al₂O₃), titania (TiO₂), zirconia (ZrO₂), ceria (CeO₂), or the like, or combinations comprising at least one of the foregoing metal oxides. Exemplary ceramic chips are those that comprise silica and/or alumina.

The chip may have any desired thickness. An exemplary thickness for the chip is about 0.3 to about 5 millimeters. As noted above, the chip 120 comprises an entry port 160 and an exit port 110. The entry port 160 is in communication with a loading pad 190 upon which a library is disposed. The loading pad 190 is generally several square millimeters in size and can be tens to several hundreds of micrometers deep. In an exemplary embodiment, the loading pad 190 is about 12 mm² in size and is up to about 20 micrometers deep. The loading pad 190 can accommodate volumes of about 100 nanoliters to about 10 microliters. The contents of the library are then transported through the entry port 160 into the flow channel 150.

The exit port 110 may be optionally attached to a lip 180. The lip 180 can optionally be in fluid communication with a pump (not shown). The pump can be used to facilitate the transportation of fluids from the entry port 160 through the flow channel 150 to the exit port 110. The lip 180 is generally manufactured from a material that does not react with fluids or elements of interest that are being investigated in the microfluidic device 100.

The pump can be active (e.g. using a syringe mechanically pressed or pulled) or capillary-based (e.g., using a wettable passivation layer 140). An exemplary syringe is a neMESYS® syringe pump from Cetoni GmbH (Gera, Del.). In case of active pumping, the lip 180 can be used to fixedly attach a capillary or tube that is in communication with the chip 120 and the pump. Optionally colored beads that are a few micrometers in diameter can be used to calibrate and monitor flow conditions in the microfluidic device 100. Beads or other flow tracers can be added to the library to accurately monitor flow rates during screening.

A metal layer 130 is disposed upon the chip 120. As noted above the metal layer 130 can be gold. Other metals onto which organic molecules can be grafted or deposited so as to form the passivation layer can also be used. For example, metals having a surface oxide can be used. Such metals are nickel, aluminum and titanium. A passivation layer can be attached to the oxide of these metals using covalent bonds or ionic interactions. An optional titanium layer can be disposed between the metal layer 130 and the chip 120 in particular if the metal layer 130 is a noble metal such as gold, which does not adhere well to glass, silicon dioxide and other oxidized surfaces. The titanium layer has a thickness of about 1 to about 5 nanometers and serves as an adhesion promoter that facilitates the bonding of the metal layer 130 with the chip 120. The metal layer 130 has a thickness of about 5 to about 50 nanometers, specifically about 8 to about 40 nanometers, and more specifically about 10 to about 25 nanometers. In an exemplary embodiment, the metal layer 130 has a thickness of about 10 to about 20 nanometers.

As noted above, the flow channel 150 is disposed upon the metal layer 130 and has as its base the metal layer 130. The flow channel 150 is in fluid communication with the entry port 160 and the exit port 110. The metal layer 130 may have disposed upon it a passivation layer 140. The passivation layer may be hydrophobic or hydrophilic. When the metal layer 130 comprises gold, the upper surface of the chip can be made hydrophobic and the engraved structures of the chip (e.g., loading pad 190, entry port 160, flow channel 150, and exit port 110) can be made hydrophilic by microcontact printing hexadecanethiol on the upper metal surface; the upper metal surface being the metal surface that does not contact the chip.

The microcontact printing with hexadecanethiol is a “dry” printing method that minimizes the spread of liquid ink on the surface upon which it is printed. Once hexadecanethiol is present on the upper metal surface, it blocks the deposition of a subsequent chemical. Therefore after the printing with hexadecanethiol, the chip 120 can be directly immersed in or covered with an ethanolic solution of a poly(ethyleneglycol) having an anchoring group for the metal. The poly(ethyleneglycol) forms the passivation layer 140 in those areas where the hexadecanethiol is absent. To treat gold surfaces, the poly(ethyleneglycol) is functionalized with thiol groups. The printing of the chip with hexadecanethiol takes only a few seconds after which the engraved structures of the chip 120 are covered with poly(ethyleneglycol). After this treatment, the engraved structures are wettable and resistant to the deposition of proteins of phages from a library.

Having the upper surface of the chip covered with a hydrophobic layer acts against leaks in the regions of the chip 120 that are sealed with the substrate 170. It also prevents adventitious spreading of a solution that is placed in the loading pad to other areas of the chip 120.

The flow channel 150 plays an important role in the screening of the library and has a geometry that ensures that a substantial majority of library elements can diffuse from the lumen of the flow channel 150 to the receptor 200. The width and length of the flow channel 150 should provide a sufficient receptor surface area so as to have enough binding sites for all the elements from the library that may bind to the receptor. Even though the length, width and depth of the flow channel 150 can be easily varied when desired, it is generally desirable to try to adhere to the following design considerations. First, the flow channel 150 should not be so wide as to ensure the collapse of the substrate 170. A flow channel 150 should not be too short or too deep otherwise the library elements entering into the flow channel 150 may not have the possibility of diffusing from the bulk of the flow channel 150 to the receptors before exiting the screening area.

In addition to the flow channel 150 geometry, the flow conditions, volumes displaced in the flow channel 150, kinetics of binding between the library element and the receptor, the receptor density and orientation on the surface, temperature, the diffusion constant of the library elements, the viscosity of the solution in which the library elements are disposed, concentration of the library and number of copies of each type of library element all interact to affect the outcome of the screening.

The flow channel 150 can have any cross-sectional geometry. The cross-section can be rectangular, square, semi-circular, circular, or polygonal. Combinations of the aforementioned geometries can also be used. An exemplary cross-section for the flow channel 150 is a rectangular or a square cross-section. The FIG. 1B is a depiction of the cross-section of the FIG. 1A taken at AA′ and depicts a rectangular cross-section for the flow channel 150.

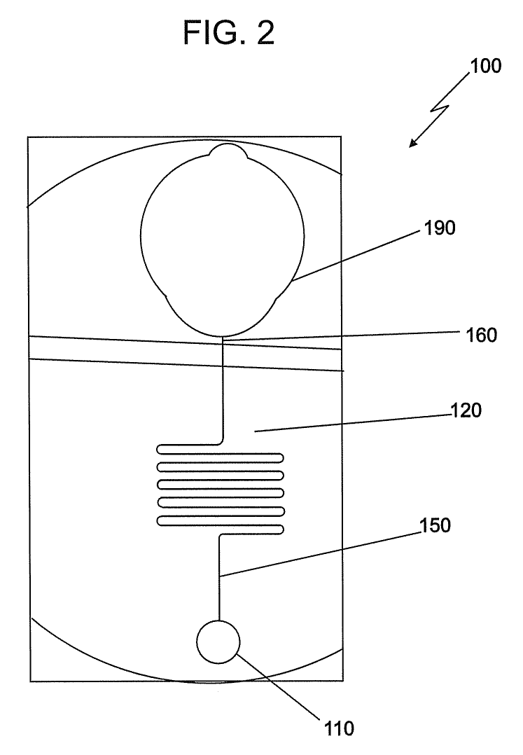

The geometry of flow channel 150 between the entry port 160 and the exit port 110 can be linear or curvaceous if so desired. It is generally desirable to minimize the number of sharp corners (e.g., right angled corners) in the direction of fluid flow in the flow channel 150. In one embodiment, it is desirable not to have any sharp corners in the direction of fluid flow along the flow channel 150. The lack of sharp corners in the fluid flow direction ensures that there is no dead volume in the flow channel 150 where elements that are to be tested or detected, such as bacteriophages, can be trapped. In general, the length of the flow channel 150 can be from about 1 millimeter to about 150 millimeters. The length can exceed 150 millimeters if desired. However, in the interest of space, it may be desirable for the flow channel to have a tortuous path between the entry port 160 and the exit port 110 when a length greater than 100 millimeters is desired. In one embodiment, the tortuous path can have a serpentine shape. In another embodiment, the tortuous path can comprise opposing U shaped curves that connected to one another as can be seen in the FIG. 2.

In one embodiment, the flow channel 150 has micrometer-sized dimensions. The micrometer-sized width and depth dimensions of the flow channel 150 ensure that the fluid flow in the flow channel 150 is always laminar. This permits the elution of a phage of interest. The flow channel 150 has a width of about 30 to about 130 micrometers, specifically about 40 to about 120 micrometers and more specifically about 50 to about 100 micrometers. An exemplary width for the flow channel 150 is about 60 micrometers. The flow channel 150 has a depth of about 10 to about 50 micrometers, specifically about 15 to about 40 micrometers and more specifically about 20 to about 30 micrometers. An exemplary depth for the flow channel is about 20 micrometers.

With reference now again to the FIG. 1A, the flow channel 150 is sealed with a substrate 170. The substrate 170 acts as an upper wall for the flow channel 150 when it is disposed on the chip 120. A receptor 200 is disposed on the substrate 170. The substrate 170 can comprise an elastomer or non-elastomeric materials such as a ceramic (as listed above) or an organic polymer (as listed above). When materials onto which receptors do not spontaneously deposit from solution are used, it is desirable to first treat them with cross linkers or hydrophobic molecules to induce the attachment of receptors from solution. In one embodiment, it may be desirable to treat the substrate 170 with hydrophobic organic polymers. If non-elastomeric materials are used as the substrate 170, they may simply be pressed against the chip 120 for sealing or alternatively, they can be glued or bonded to the chip 120.

In one embodiment, the substrate 170 generally comprises an elastomer that has a compression modulus (also called Young's modulus) of less than or equal to about 10⁷ megapascals (MPa), specifically less than or equal to about 10⁶ (MPa) when tested at room temperature. The elastomeric properties of the substrate cause it to efficiently seal the microstructures over which it is placed. The substrate generally covers the flow channel 150 from the entry port 160 to the exit port 110. The substrate does not cover the loading pad 190. The elastomer can be hydrophilic or hydrophobic. In an exemplary embodiment, it is desirable for the elastomer to be hydrophobic. An elastomer that is hydrophilic may thus have its surface being converted to hydrophobic by coating it with a hydrophobic material such as a diblock copolymer having one hydrophilic and one hydrophobic domain.

Suitable elastomers that can be used for the substrate 170 are polysiloxanes such as polydimethylsiloxane; natural and synthetic polyisoprene, polybutadiene, styrene butadiene copolymers, copolymers of isobutylene and isoprene, chlorobutyl rubber, bromobutyl rubber, copolymers of polybutadiene and acrylonitrile, epichlorohydrin rubber, polyacrylic rubber, fluorosilicone rubber, chlorosulfonated polyethylenes, or the like, or a combination comprising at least one of the foregoing elastomers. An exemplary elastomer is polydimethylsiloxane.

The substrate 170 generally has a thickness of about 0.5 to about 5 millimeters. The surface of the substrate 170 that is opposed to the metal layer 130 is partially or completely covered with a receptor 200 (also referred to as the target). The receptor is selected depending upon its ability to interact with certain desired elements of the library. The receptor can be an enzyme, a peptide, a protein, inorganic particles, beads coated with a receptor, uncoated beads, cells, glycans, viral particles, polymers, antibodies, antigens or other type of molecule or material that can have a ligand-receptor type of interaction with proteins or peptides displayed by bacteriophages. The receptor can for example be patterned on the substrate surface using stencils, inkjet deposition methods or other methods for patterning proteins on surfaces. Alternatively, the receptor can be deposited onto the substrate by flowing a solution of a receptor in the flow channel 150 after it is sealed with the substrate 170.

In one embodiment, in one method of using the microfluidic device 100, a library of bacteriophages is disposed on the loading pad 190. Here the elements of the library are described with specific reference to bacteriophages. While the method disclosed herein describes the use of library of bacteriophages, other libraries comprising viruses, self assembled molecules, or the like may also be used. A first solution is added to the loading pad 190 to transport the bacteriophages through the entry port 160 into the flow channel 150. Once in the flow channel 150, the bacteriophages encounter the receptor. Binding occurs between selected bacteriophages and the receptor, depending upon the choice of the receptor. The first solution in the flow channel 150 can then be pumped out using the pump that is in fluid communication with the lip. In another embodiment, the first solution in the flow channel can be forced out of the flow channel using capillarity. In yet another embodiment, an amount of washing solution can be introduced into the flow channel to displace the previously introduced first solution from the flow channel.

After removing the first solution from the flow channel by washing, an elution solution is added to the flow channel via the loading pad and the entry port to elute the bacteriophages, which are bound to receptors disposed upon the substrate 170. The goal of the elution step is to separate the phages from the receptors so as to retrieve them for analysis using conventional methods based on, for example, DNA sequencing. Alternatively, some characteristics of the phage-receptor binding interaction can be analyzed before the elution step. These interactions can be investigated using radioactivity, fluorescence, chemiluminescence, phosphorescence, enzymatic activity, micro-calorimetry, mass-spectroscopy, or the like. Typically, eluted phages are multiplied using bacterial hosts to amplify their number and make them more convenient to handle and analyze.

In one embodiment, in one manner of manufacturing the microfluidic device, a flow channel 150, entry port 160, loading pad 190 and exit port 110 are created in a wafer by conventional photolithography and deep reactive ion etching. Using more than one photoexposure and etching steps, it is possible to create the structures listed above with different depths. The loading pad can be made deeper than the flow channel, for example, so that the loading pad can accommodate microliters of solution. The exit port 110 is typically etched through the wafer to permit the bonding of a lip 180 to the chip 120. Having the lip on the opposite face of the chip from the flow channel and the receptor simplifies the communication between the flow channel and the pump and does not disturb the position and seal of the substrate 170 on the chip 120. Other etching methods such as chemical etching may also be used to form the flow channel or other structures. Exit ports can be drilled or laser ablated for example. The optional titanium layer and the metal layer 130 may be disposed on the wafer by sputtering. The passivation layer 140 may then be disposed on the metal layer 130 by microcontact printing hexadecanethiol onto the upper surface of the chip 120 and then flowing a solution of thiolated poly(ethylene glycol) in ethanol over the chip, after which the chip is rinsed with ethanol and blown dry.

The substrate 170 is generally manufactured by cutting a sheet of elastomer to the desired size and disposing it on the chip 120. The receptor 200 is disposed on the substrate 170 by exposing the surface of the substrate 170 to a solution of the receptor 200 and letting the receptor 200 adsorb non-reversibly to the substrate 170 surface. The disposing of the receptor 200 on the substrate 170 is generally conducted prior to the disposing of the substrate 170 on the flow channel 150. In one embodiment, the surface of the substrate 170 to which the receptor 200 is to be bound may first be treated with a coupling agent to enhance the non-reversible bonding of the receptor to the surface of the substrate. Suitable coupling agents are silane coupling agents. The seal and the lip 180 may then be affixed to the wafer to form the microfluidic device using a standard thermocurable adhesive.

This device is advantageous in that it permits libraries containing a large number of elements to be rapidly tested and analyzed. While most applications involve the use of biological molecules, virtually any molecule can be detected if a specific binding partner is available or if the molecule itself can attach to the receptor as described above.

The invention is further described by the following non-limiting examples:

### EXAMPLE

### Example 1

This example was conducted to demonstrate the screening of a library against streptavidin. The microfluidic device had a silicon wafer for a chip and a polydimethylsiloxane (PDMS) substrate. The flow channel had a depth of 20 micrometers and a width of 60 micrometers. The receptor comprised streptavidin.

A phage display library encoding dodecapeptides (M13 bacteriophage library from New England Bio labs #E 8110S) was screened against streptavidin, which was immobilized on the PDMS substrate. The microfluidic chip used for this screening is shown in FIGS. 1 and 2, both of which are previously described above. Streptavidin (provided with the library) was deposited on the PDMS substrate by coating the PDMS surface with a 0.1 microgram per milliliter (μg-mL⁻¹) solution of spreptavidin in phosphate buffer saline (PBS) overnight. After rinsing with PBS, deionized water and drying under a stream of N₂, the PDMS was covered with a solution of 0.5% (in weight) of bovine serum albumin (BSA) and 0.1 μg mL⁻¹ solution of spreptavidin in PBS for blocking the surface of PDMS not initially covered with streptavidin. This blocking step helps preventing non-specific interaction of phages with bare PDMS. After rinsing with PBS, deionized water, and drying, the PDMS substrate was placed on the silicon wafer having the flow channel without covering the loading pad.

The library was dialyzed against tris-buffered saline (TBS) for approximately 4 hours. During this step, the library volume increased from approximately 10 to approximately 50 microliters (μL). The library was pipetted onto the loading pad using approximately 10 μL fractions and passed through the flow channel at a flow rate of 30 microliters per hour (μL h⁻¹). The fraction of the library collected after passing through the flow channel is termed “waste”. The waste was kept for future tittering that is counting phages present in the solution. The flow channel was then rinsed with TBS containing 0.1% of Tween 20 (a surfactant available from Fluka, Switzerland). A solution of 1 to 3% BSA in PBS or TBS with 0.1% Tween 20 was placed around the PDMS and the PDMS was separated from the chip and rinsed with TBS with 0.1% Tween 20. Bound phages were eluted from the surface using a 0.1 mM solution of biotin in PBS for 1 hour at room temperature. The number of eluted phages was tittered using the protocol recommended by the supplier of the library: the eluate was amplified using E coli as host and agarose plates as growth medium.

Dilution series of the amplified culture was performed and used to streak agarose plates. Plaque forming units (pfu) were counted to assess the concentration of the phages in the eluate. The concentration of phages in the waste was also assessed using this method.

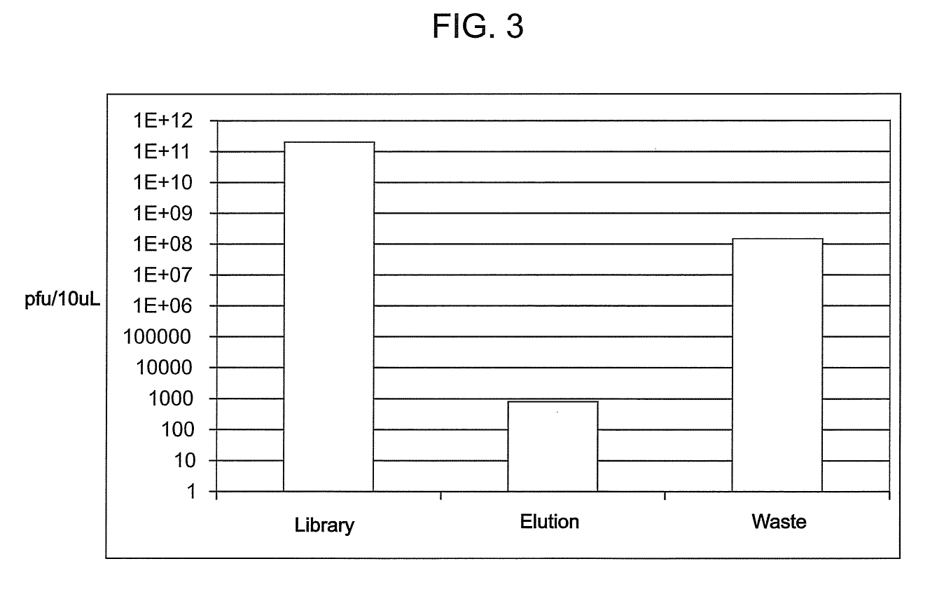

FIG. 3 is a bar graph showing how efficient the reduction of the library was in only one round of screening. Whereas 2 to 3 rounds of screening are generally used when using conventional microtiter plates, here a strong reduction of the library was achieved in only one round. The number of phages per 10 μL diminished from ˜10¹¹ phages (library) to ˜10³ phages (eluate). This strong reduction in the library size originates from the screening of the library under “microfluidic conditions”. In the microfluidic device, laminar flow occurs and little, if no dead volumes exists. As a result, flow of solutions are precise in volume, rate, and the rinsing is very efficient. The dynamics of reactions are dramatically affected by scale; controlling the dimensions and flow conditions of the flow channel can shift reaction parameters such as diffusion and kinetics of binding in favor of selection. Furthermore, microfluidic channels are closed systems and can be used to eliminate outside contamination. Controlling the surface chemistry of a microtiter plate and latex beads is empirical due to imperfections in those surfaces. Utilization of well-defined surfaces in microfluidic devices allows for greater control over surface passivation, binding to the target of interest, and availability of target. The total area of target on a surface can even be reduced to induce a competition between binding elements of the library. By having stronger binders replacing weaker ones, selection can be increased. This can be done with this invention by patterning a target on the surface of PDMS and utilizing small flow rates.

### Example 2

This example was conducted to screen a library for hemagglutinin epitopes. A phage display library encoding dodecapeptides (M13 bacteriophage library from New England Biolabs #E 8110S) was screened against an antibody (Ab) target. This Ab is directed against a synthetic peptide (9 amino acid sequence YPYDVPYA) from hemagglutinin influenza virus and is a monoclonal mouse Ab (#H1200-3, IgG, clone 3H428B from USBiological, Ma, USA). The buffer of the library was TBS (tris buffered saline, i.e., 50 mM Tris-HCl, pH 7.5, 150 mM NaCl) with 50% of glycerol. The complexity of the library was 2.7×10⁹ transformants. Ten μL of the library contains approximately 55 copies of each sequence.

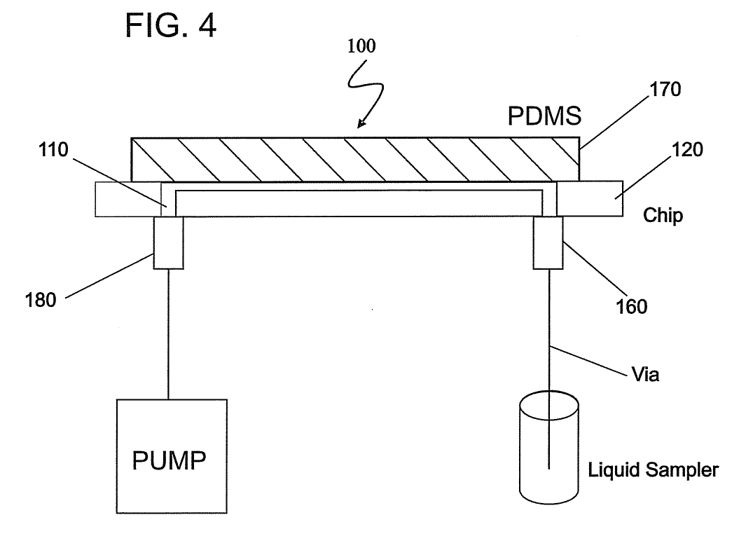

The microfluidic device used for screening this library had a similar design as that described in Example 1 except that the loading pad for loading the library was replaced by a via, as can be seen in the FIG. 4. The via was connected to a Nanoport, a polyether ether ketone (PEEK) tubing (0.09 inch diameter and about 10 centimeters long). The tubing was immersed in an Eppendorf tube (1.5 mL or smaller). Here, large volumes of solution and long steps can be conveniently used if desired. After sealing the flow channel of the microfluidic device with the substrate, the antibodies were passed through the flow channel (50 μm deep and 100 μm wide, 15-mm-long channel) at a flow rate between about 1 to about 5 μL min⁻¹. The antibodies were diluted in PBS at a concentration of 20 to 125 μg mL⁻¹. After 15 min, the microfluidic channel was rinsed with PBS for 15 minutes at a flow rate of about 5 to about 10 μL min⁻¹. Rinsing at a relatively high flow rate may help to remove those antibodies that are weakly bound to the substrate. Areas that were not covered with the antibodies were blocked with BSA to prevent non-specific deposition of phages in subsequent steps. This was done by flowing a solution of BSA in PBS (at a concentration of 1 to 3% of BSA in PBS) for 60 minutes using a flow rate of about 1 to about 5 μL min⁻¹. Finally, the flow channel was rinsed with TBS for 1 hour at a flow rate of about 5 to about 10 μL min⁻¹. TBS was selected for this rinsing step because it is the buffer used for the library. Other buffers such as PBS can also be used.

The library was dialyzed (Slide-A-Lyzer from Pierce, Ill., USA, molecular weight cut-off: 3500 Daltons) to remove glycerol or lower its initial concentration. In general, if 10 μL of the library were screened, 1.5 times the volume of the library would be dialyzed. For example, 15 μL of library was dialyzed overnight at room temperature in 1 liter of TBS. Shorter times can also be used. This dialysis step removes glycerol and therefore lowers the viscosity of the library sample thereby improving the diffusion of the phages in the solution. Typically, 10 μL of the dialyzed library (corresponding to about 4×10¹⁰ phages) were added to 100 μL of TBS having 0.1% Tween 20.

The library was then passed under a stop flow condition (here, 21 minutes at a flow rate of 2 μL min⁻¹ followed by 1 minute without flow) wherein the volume of library discharged through the flow channel was determined by the volume of the channel and the incubation time determined by the maximum length of diffusion to the target area (i.e. channel depth) based on the diffusion constant for the M13 bacteriophage. The final constraint for the stop flow condition was that a phage at the bottom of the channel at the entrance of the channel should have enough time to diffuse to the top of the channel before it exits the channel. Since the flow channel used here had a depth of 50 μm and a length of only 15 mm, a slow flow rate was applied. In addition, the amount of hysteresis in the pump system (the time between when the pump stops and the flow of elements in the liquid stops) was empirically determined using fluorescent beads to improve the accuracy of the stop flow conditions.

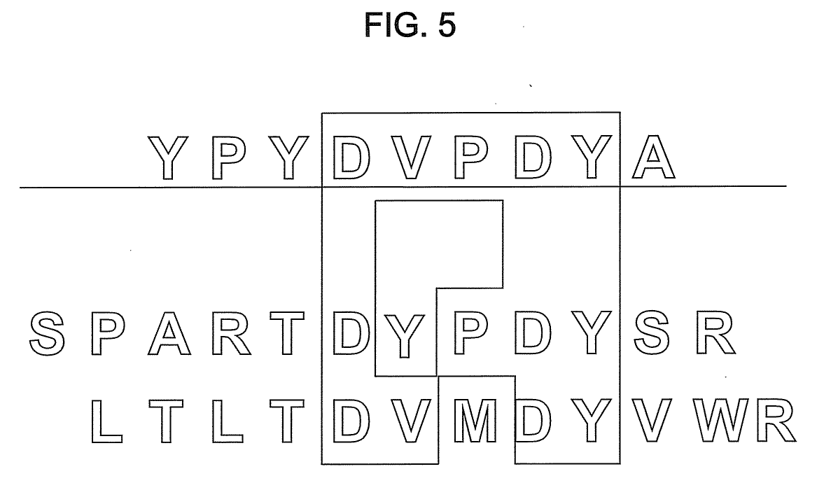

The library passed through the flow channel in 20 hours (approximately 5 μL per hour), a time that can be reduced by making the flow channel wider or longer. Then, rinsing was done by discharging TBS with 0.1% Tween 20 through the flow channel followed by TBS for about 4 to about 6 hours at a flow rate of about 10 to about 15 μL min⁻¹. The phages retained in the flow channel were eluted by flowing a YPYDVPYA control peptide (50 μg in 600 μL of PBS) at a flow rate of about 5 μL min⁻¹. Slower and faster flow rates can also be used. The phages were collected in 30 minutes elution increments, amplified in E coli, and sequenced for analysis. Sequences obtained are reported in the FIG. 5. Remarkably, in only one round, the first elution aliquot contained phages that had sequences having a similarity with the known epitope HA well above the statistical levels (calculated using the method described in the commercial brochure of the library) of the library. This demonstrates that selection occurred with this microfluidic-based screening method.

Although the examples described above are based on bacteriophage libraries, other types of library can be used. Libraries using other types of viruses, or using self-assembled structures such as vesicles, or using beads or nanoparticles, which can all be coated with elements so as to form a library, can also be screened using the methods disclosed herein. Libraries based on cells can also be used. Libraries of chemicals, polymers, inorganic compounds, glycans, naturally active compounds, peptides, and oligonucleotide can also be screened using the method and system disclosed herein.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A system comprising:
a chip;
a flow channel disposed in the chip; the flow channel being in communication with an entry port and an exit port; the flow channel being operative to permit the flow of a library from the entry port to the exit port;
a substrate; the substrate being disposed upon the chip; the substrate being operative to act as an upper wall for the flow channel; and
a receptor; the receptor being disposed on the substrate; the receptor being operative to interact with an element from the library.

2. The system of claim 1, wherein the flow channel is coated with a metal layer.

3. The system of claim 2, wherein the metal layer comprises gold.

4. The system of claim 1, wherein the chip comprises silicon.

5. The system of claim 1, wherein the chip comprises an organic polymer.

6. The system of claim 1, wherein the chip comprises a metal oxide; the metal oxide being silica, alumina, titania, zirconia, ceria, or combinations comprising at least one of the foregoing metal oxides.

7. The system of claim 1, wherein the flow channel has a width of 30 to about 130 micrometers.

8. The system of claim 1, wherein the flow channel has a depth of about 10 to about 50 micrometers.

9. The system of claim 1, wherein the flow channel has a length of about 1 to about 150 millimeters.

10. The system of claim 1, wherein the flow channel has a path that is tortuous.

11. The system of claim 1, wherein the substrate comprises an elastomer; the elastomer being a polysiloxane; natural polyisoprene; synthetic polyisoprene; polybutadiene; styrene butadiene copolymers; copolymers of isobutylene and isoprene; chlorobutyl rubber; bromobutyl rubber; copolymers of polybutadiene and acrylonitrile; epichlorohydrin rubber; polyacrylic rubber; fluorosilicone rubber; chlorosulfonated polyethylenes; or a combination comprising at least one of the foregoing elastomers.

12. The system of claim 1, wherein the substrate comprises polydimethylsiloxane.

13. The system of claim 1, wherein the receptor comprises an enzyme, a peptide, a protein, an inorganic particle, a cell, a glycan, a viral particle, a polymer, an antibody, an antigen, or a combination comprising at least one of the foregoing receptors.

14. The system of claim 1, further comprising a pump; the pump being in communication with the exit port.

15. The system of claim 1, further comprising a loading pad; the loading pad being in communication with the entry port.

16. An article that uses the system of claim 1.

17. A method comprising:
disposing a library on a loading pad of a microfluidic device; the microfluidic device comprising:
a chip;
a flow channel disposed in the chip; the flow channel being in communication with an entry port and an exit port; the flow channel being operative to permit the flow of a library from the entry port to the exit port;
a substrate; the substrate being disposed upon the chip; the substrate being operative to act as an upper wall for the flow channel; and
a receptor; the receptor being disposed on the substrate; the receptor being operative to interact with an element from the library;
adding a first solution to the loading pad to transport elements of the library through the entry port into the flow channel;
binding a fraction of the elements of the library to the receptor to form a element-receptor complex; and
eluting a element-receptor complex.

18. The method of claim 17, further comprising amplifying those elements of the library that are able to bind to the receptor.

19. The method of claim 17, further comprising analyzing those elements of the library that are able to bind to the receptor; the analysis being conducted by analytical techniques; the analytical techniques comprising oligonucleotide sequencing, radioactivity, fluorescence, chemiluminescence, phosphorescence, enzymatic activity, mass-spectroscopy, calorimetry, or a combination comprising at least one of the foregoing analytical techniques.

20. The method of claim 17, wherein the eluting of the element-receptor complex is accomplished using a second solution.

21. A method of manufacturing a microfluid device comprising:
disposing a flow channel in a chip;
disposing an exit port and a loading pad in the chip;
disposing a metal layer on a base of the flow channel;
disposing a substrate on the chip; the substrate being operative to act as an upper wall for the flow channel; and
disposing a receptor on a surface of the substrate that is opposedly disposed to the metal layer; the receptor being operative to interact with an element of a library.

22. The method of claim 21, wherein the chip is microfabricated.

23. The method of claim 21, wherein the chip does not seal an entry port; the entry port being in communication with the loading pad.

24. An article manufactured by the method of claim 21.
